(19) United States
(12) Patent Application Publication
(10) Pub. No.: US 2024/0429460 A1
(43) Pub. Date: Dec. 26, 2024

(54) RECHARGEABLE ALKALINE BATTERY WITH ENHANCED CYCLING STABILITY AND COULOMBIC EFFICIENCY

(71) Applicant: The Hong Kong University of Science and Technology, Hong Kong (CN)

(72) Inventors: Qing CHEN, Hong Kong (CN); Yilin MA, Hong Kong (CN); Liangyu LI, Hong Kong (CN)

(21) Appl. No.: 18/673,364

(22) Filed: May 24, 2024

Related U.S. Application Data
(60) Provisional application No. 63/509,286, filed on Jun. 21, 2023.

(51) Int. Cl. H01M 10/26; H01M 4/02; H01M 4/24; H01M 4/32; H01M 50/491; H01M 50/497

(52) U.S. Cl. CPC H01M 10/26; H01M 4/244; H01M 4/32; H01M 50/491; H01M 50/497; H01M 2004/027; H01M 2004/028

(57) ABSTRACT

The present invention provides a rechargeable alkaline battery with enhanced cycling stability and coulombic efficiency. The battery includes a cathode prepared with a cathode material and connected to a first terminal, an anode prepared with an anode material and connected to a second terminal, a hydroxide electrolyte with a higher concentration, and at least one porous separator positioned between the anode and the cathode. The hydroxide electrolyte inhibits hydrogen evolution from approximately 20% to less than 5% of an overall reaction. When cycled at 40% DOD under charging and discharging at 15 mA/cm_{Zn}², the rechargeable alkaline battery exhibits a cycling stability with a capacity retention of >80% after 290 cycles.

### CROSS-REFENCE TO RELATED APPLICATIONS

The present application claims the priorities from the U.S. provisional patent application Ser. No. 63/509,286 filed Jun. 21, 2023, and the disclosure of which is incorporated herein by reference in its entirety.

### FIELD OF THE INVENTION

The present invention pertains to the field of electrochemical technology. More specifically, the present invention relates to a super-concentrated hydroxide electrolyte with a wide electrochemical stable window and an application thereof.

### BACKGROUND OF THE INVENTION

Rechargeable zinc batteries have attracted extensive attention in recent years due to their high safety, high energy density, environmental friendliness, and low cost of zinc metal. The operational principles of zinc batteries vary depending on the acidity or alkalinity of the electrolyte they employ. Among them, alkaline zinc batteries stand out due to their distinct advantages over neutral batteries. In alkaline electrolytes, the discharging process of Zn anode involves a conversion between Zn and ZnO over short distance, contributing to the alleviation of shape change and dendrite formation in some extent. Therefore, alkaline zinc batteries can usually achieve high areal capacities of >10 mAh/cm².

Furthermore, the zinc electrode presents a viable alternative to metal hydrides in nickel metal hydride cells, leveraging established cathode and cell architectures to yield immediate practical benefits. Nevertheless, the large-scale commercial application of rechargeable alkaline Zn batteries has not been fully realized owing to several critical issues at the electrode interface, especially the hydrogen evolution reaction (HER) and passivation of the Zn anode during cycling.

Theoretically, these interfacial phenomena are closely related to a crucial component of the electrolyte, that is, the concentration of alkali hydroxide in the electrolyte. During the discharging process, the solubility of ZnO within the electrolyte determines the storage mode of zincate ions, which is positively correlated to the concentration. When exceeding the solubility, the formation of a passivation layer by the ZnO released from the decomposition of zincate ions thus limits the Zn cell operating at high depth of discharge (DoD). Meanwhile, as a result of the lower equilibrium potential of Zn/Zn²⁺ in conventional alkaline electrolytes compared with that of reversible hydrogen electrodes, hydrogen evolution reaction tends to occur thermodynamically preferentially, resulting in loss of electrolyte volume and decreased coulombic efficiency (CE).

A viable solution to these challenges must simultaneously enhance the solubility of ZnO while bolstering the electrochemical stability of the electrolyte itself. This invention addresses this need.

### SUMMARY OF THE INVENTION

Previous works do not utilize high concentrations of metal hydroxide(s) and oxides for low water activity within a broad electrochemical range, and the reported batteries do not show high efficiency and long stability at a deep depth of discharge. The present invention aims to expand the narrow electrochemical window of alkaline electrolytes for applications in high voltage, high energy-density rechargeable batteries.

In a first aspect, the present invention provides a rechargeable alkaline battery with enhanced cycling stability and coulombic efficiency. The battery includes a cathode prepared with a cathode material and connected to a first terminal, an anode prepared with an anode material and connected to a second terminal, a hydroxide electrolyte with a higher concentration, and at least one porous separator positioned between the anode and the cathode. The hydroxide electrolyte includes a solute and a solvent, with a concentration of at least 10 M. It inhibits hydrogen evolution from approximately 20% to less than 5% of an overall reaction.

In an embodiment, the anode material includes zinc, zinc alloys, zinc hydroxide, zinc oxide, or other zinc compounds of low alkaline solubility.

In an embodiment, the cathode material includes nickel oxyhydroxide.

In an embodiment, the battery comprises at least one porous separator including a nonwoven cellulose membrane, a polymer film, an ion-selective membrane, and a glass fiber separator.

In an embodiment, the rechargeable alkaline battery includes nickel-zinc, silver-zinc, and zinc-air battery.

In an embodiment, the solute is one or more alkali metal hydroxides selected from lithium hydroxide, sodium hydroxide and potassium hydroxide, calcium hydroxide, aluminum hydroxide, or a combination thereof. The solvent includes deionized water, ethanol, and dimethyl sulfoxide. The concentration of the one or more alkali metal hydroxides is 1-20 mol/L.

In another embodiment, the solute further comprises a metallic oxide comprising zinc oxide, alumina, boron oxide, tin oxide, or a combination thereof. The concentration of the metallic oxide is 0.001-5 mol/L.

The present invention utilizes high concentrations of metal hydroxide(s) and/or oxides to limit the activity of water for a large electrochemical window, while maintaining the high ionic conductivity due to the structural diffusion of hydroxide ions. With hydroxide concentrations at 15 M, the practical electrochemical window of the electrolyte can be expanded to at least 2.1 V, at an ionic conductivity of at least 0.2 S/cm at room temperature.

When applied to a rechargeable alkaline battery (e.g., alkaline zinc battery), the electrolytes can greatly suppress the amount of hydrogen evolution, stabilizing the battery for long periods of deep cycles.

When cycled at 40% DOD under charging and discharging at 15 mA/cm_{Zn}², the rechargeable alkaline battery exhibits a cycling stability with a capacity retention>80% after 290 cycles.

When cycled at 60% DOD under charging and discharging at 30 mA/cm_{Zn}², the rechargeable alkaline battery exhibits a capacity retention greater than 95% after 90 cycles, maintaining a coulombic efficiency of at least 95%, and further sustains operation for over 135 cycles while retaining a specific capacity of 60%.

Preferably, when cycled at 60% DOD under charging and discharging at 30 mA/cm_{Zn}², the rechargeable alkaline battery exhibits a capacity retention>96.77% after 90 cycles, maintaining a coulombic efficiency>96.77%, and further sustains operation for over 135 cycles while retaining a specific capacity of 60%.

### BRIEF DESCRIPTION OF THE DRAWINGS

Embodiments of the invention are described in more details hereinafter with reference to the drawings, in which:

FIG. 1 shows a configuration of Zn∥NiOOH coin cell according to an embodiment of the present invention;

FIG. 2 depicts electrochemical stability window and ionic conductivity of 6 M, 9M, 12 M and 15M KOH electrolytes;

FIG. 3 depicts linear sweep voltammetry of hydrogen evolution behavior in 15M KOH electrolyte with saturated Al₂O₃;

FIG. 4 depicts a polarization curve of Zn∥NiOOH coin cell based on a super-concentrated hydroxide electrolyte according to an embodiment of the present invention;

FIG. 5 depicts cycle performance under 40% DOD of Zn∥NiOOH coin cell based on a super-concentrated hydroxide electrolyte according to an embodiment of the present invention; and

FIG. 6 depicts cycle performance under 60% DOD of Zn∥NiOOH coin cell based on a super-concentrated hydroxide electrolyte according to an embodiment of the present invention.

### DETAILED DESCRIPTION

The present invention provides a rechargeable alkaline battery with enhanced cycling stability and coulombic efficiency. The battery includes a cathode prepared with a cathode material and connected to a first terminal, an anode prepared with an anode material and connected to a second terminal, a hydroxide electrolyte with a higher concentration, and at least one porous separator positioned between the anode and the cathode. The hydroxide electrolyte includes a solute and a solvent, with a concentration of at least 10 M. It inhibits hydrogen evolution from approximately 20% to less than 5% of an overall reaction.

In one embodiment, the rechargeable alkaline battery may include nickel-zinc battery, silver-zinc battery, and zinc-air battery.

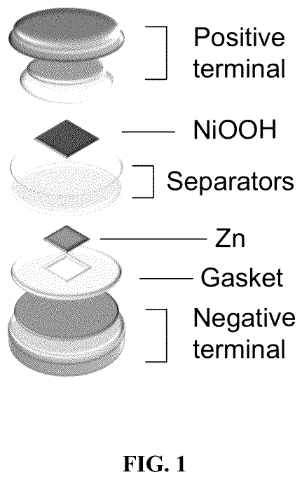

A typical electrochemical performance of the water in hydroxide electrolyte were systematically investigated in the Ni—Zn batteries. Turning to FIG. 1, the assembly process of a Zn∥NiOOH coin cell involves several components arranged in a specific sequence to ensure proper functionality. Firstly, the construction of a button cell battery begins with the preparation of a cathode, which includes a cathode material and is connected to a first terminal. In particular, a NiOOH (nickel oxyhydroxide) layer is applied onto the terminal. Following this, a separator is carefully placed over the NiOOH layer to prevent direct contact with the anode and facilitate ion transport. Subsequently, an anode is deposited onto the separator. The anode material includes a zinc (Zn) layer, and the anode is connected to a second terminal. To ensure proper sealing and insulation, a gasket is then inserted around the perimeter of the assembly. Finally, the second terminal, typically composed of a conductive material similar to the first terminal, is affixed to complete the circuit.

In one embodiment, the cathode material may be nickel oxyhydroxide. The cathode material may also be iron or iron analogs, such as nickel-iron oxide, manganese-iron oxide, chromium-iron alloy, molybdenum-iron alloy, titanium-iron alloy, vanadium-iron alloy, copper-iron alloy, cobalt-iron alloy, etc.

The anode material may be zinc, zinc alloys, zinc hydroxide, zinc oxide, or other zinc compounds of low alkaline solubility. In another embodiment, the anode material may also be aluminum or aluminum analogs, boron or boron analogs, both of which offer distinct advantages in certain electrochemical applications. For instance, the aluminum analogs may be aluminum oxide, aluminum hydroxide. The boron analogs may be boron trioxide, boric acid.

The at least one porous separator acts as a barrier to maintain the integrity of the battery's internal structure. The porous separator may be a nonwoven cellulose membrane, a polymer film, an ion-selective membrane, or a glass fiber separator. Polymer films used for battery separators need to possess good ion transport performance, chemical stability, thermal stability, and mechanical strength. For instance, the polymer film may be polypropylene (PP) film, polyester (PET) film, polytetrafluoroethylene (PTFE) film, polyethylene (PE), etc.

Preferably, the porous separator may be Celgard® 3501 separator.

The electrolyte disclosed in the present invention pertains, specifically but not exclusively, to water-in-hydroxide electrolytes capable of addressing the limited electrochemical window inherent in water-based electrolytes. These electrolytes are designed to uphold ionic conductivity while enhancing the cycling stability and coulombic efficiency of rechargeable alkaline batteries, such as nickel-zinc, silver-zinc, and zinc-air batteries.

Hydroxide electrolyte typically refers to an electrolyte solution or solid containing hydroxide (OH⁻) ions. In one embodiment, the hydroxide electrolyte is formed by an aqueous mixture of a solute and a solvent. The solute may include one or more than two of high-concentration alkali metal hydroxides salts with or without the addition of metallic oxide or metal hydroxide, such as lithium hydroxide, sodium hydroxide, potassium hydroxide, calcium hydroxide, aluminum hydroxide, zinc oxide, alumina, boron oxide, tin oxide, or a combination thereof. The solvent may include deionized water, ethanol, and dimethyl sulfoxide.

In one embodiment, the hydroxide electrolyte has a concentration in a range of 6-10 M.

Preferably, the hydroxide electrolyte has a concentration of at least 10 M. For example, the concentration can be 11M, 12M, 13M, 14M, or 15M.

In one embodiment, the hydroxide electrolytes can be alkaline solutions such as sodium hydroxide (NaOH) or potassium hydroxide (KOH), or organic solutions containing hydroxide ligands such as trimethylamine hydroxide (TMHAOH). Additionally, hydroxide electrolytes can also be solid materials, such as aluminum hydroxide (Al(OH)₃) or sodium hydroxide pellets (NaOH). These hydroxides play essential roles in ion conduction and catalyzing reactions in electrochemical processes.

In one embodiment, the concentration of the one or more alkali metal hydroxides is 1-20 mol/L.

Preferably, the concentration of the one or more alkali metal hydroxides is 9-20 mol/L.

More preferably, the concentration of the one or more alkali metal hydroxides is 15-20 mol/L.

In one embodiment, the concentration of the metallic oxide is 0.001-5 mol/L.

Preferably, the concentration of the metallic oxide is 0.1-5 mol/L.

The electrolyte can effectively inhibit hydrogen evolution reaction by distinct electrolyte structure and low water activity. The electrolyte structure comprises pairs of metal cations and hydroxide anions, which exclude a fraction of water molecules typically in cation solvation shells that undergo facile a hydrogen evolution reaction. The low water activity decreases both the driving force for hydrogen evolution and its reaction kinetics. The electrolyte retains high ionic conductivity due to the unique hydroxide structure diffusion. These improvements are observed in rechargeable alkaline batteries, including nickel-zinc, silver-zinc, and zinc-air batteries, attaining superior cycling stability and coulombic efficiency even at substantial depths of discharge.

In the following description, specific details are provided to offer a comprehensive understanding of the present invention, for explanatory purposes and not intended for limitation.

### EXAMPLE

### Example 1

### Preparation of Aqueous KOH Electrolyte

A typical electrolyte was formulated by weighing different masses (molality) of the commercial high-purity chemical potassium hydroxide in ultrapure water, denoted as 15 M KOH electrolyte. Gold foil, platinum sheet, and Hg/HgO were employed as a working electrode, a counter electrode, and a reference electrode respectively, in the assembly of a three-electrode battery for testing.

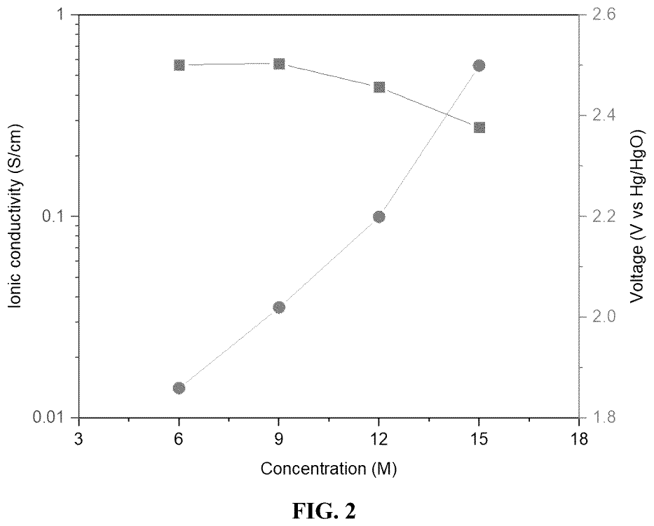

The KOH electrolyte exhibited a widened electrochemical stability window exceeding 2.5 V, with both cathodic and anodic limits well beyond the theoretical decomposition voltage of water (1.23 V). Additionally, it maintained a relatively high ionic conductivity of 0.2774 S/cm at room temperature (FIG. 2).

### Example 2

### Preparation of NaOH-KOH mixed aqueous electrolyte

A typical NaOH—KOH mixed aqueous electrolyte was prepared by weighing different masses (molality) of the commercial high-purity chemical potassium hydroxide and sodium hydroxide in ultrapure water. The total concentration of mixed solutes in the electrolyte is 20 mol/L. Sn foil, platinum sheet, Hg/HgO were employed as a working electrode, a counter electrode, and a reference electrode, respectively, in the assembly of a three-electrode battery for testing.

The electrolyte exhibited an effectively inhibition of hydrogen evolution reaction with a much lower onset potential of −1.6 V with a relatively high ionic conductivity in room temperature.

### Example 3

### Preparation of Alkaline Aqueous Electrolyte with Saturated Al₂O₃

A typical alkaline aqueous electrolyte with saturated Al₂O₃ was prepared by weighing different masses (molality) of the commercial high-purity chemical potassium hydroxide in ultrapure water. Subsequently, saturated Al₂O₃ was formed by dissolving Al₂O₃ powder in pure KOH solution at a higher temperature, which was then cooled to room temperature and filtered. Sn foil, platinum Foil, and Hg/HgO were employed as a working electrode, a counter electrode, and a reference electrode, respectively, in the assembly of a three-electrode battery for testing.

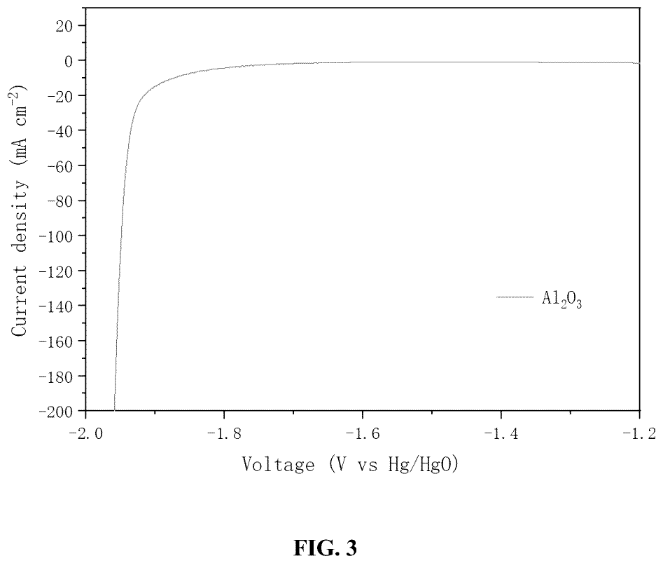

The electrolyte exhibited an effectively inhibition of hydrogen evolution reaction with a much lower onset potential of −1.6 V (FIG. 3).

### Example 4

### Alkaline Ni—Zn Batteries with Super-Concentrated Electrolyte

FIG. 1 showed a coin-cell design employing a water-in-hydroxide electrolyte, based on NiOOH∥Zn configuration. The design adopted a bi-continuous nanoporous (NP) Zn anode, a NiOOH/Ni(OH)₂ cathode, and at least one porous separator including a nonwoven cellulose membrane (16 mm in diameter, 100 μm thick, 75% porosity) and a Celgard 3501 separator (16 mm diameter, thickness: 25 μm, porosity: 55%). The NiOOH/Ni(OH)₂ cathode (1 cm²) was obtained and directly used from fully charged commercial NiMH AAA batteries (2600 mAh, GP Batteries). For anodes cycled at 40% DOD, a solution consists of 15M KOH with saturated ZnO was used as the electrolyte for the cathode and separators. While the anode was infiltrated with the solution of 6 M KOH/1 M LiOH in which 10 wt % Ca(OH)₂ was suspended before the assembly. For anodes cycled at 60% DOD, the aqueous electrolyte was 15 M KOH/saturated ZnO with the addition of 10 wt % Ca(OH)₂.

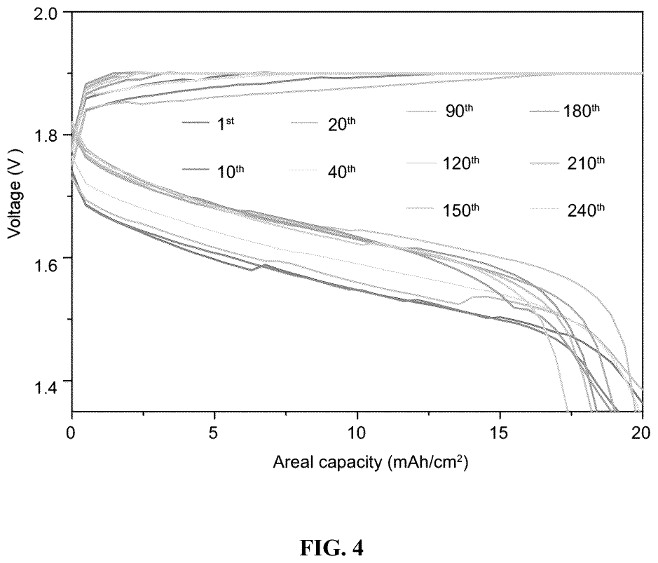

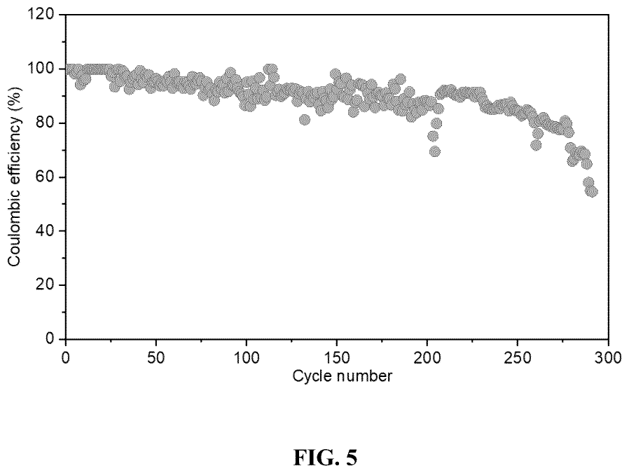

FIGS. 4-5 showed the stability performance of the prepared Ni—Zn batteries when cycled at 40% DOD under charging and discharging at 15 mA/cm_{Zn}², which delivers excellent cycling stability with a high-capacity retention>80% after 290 cycles.

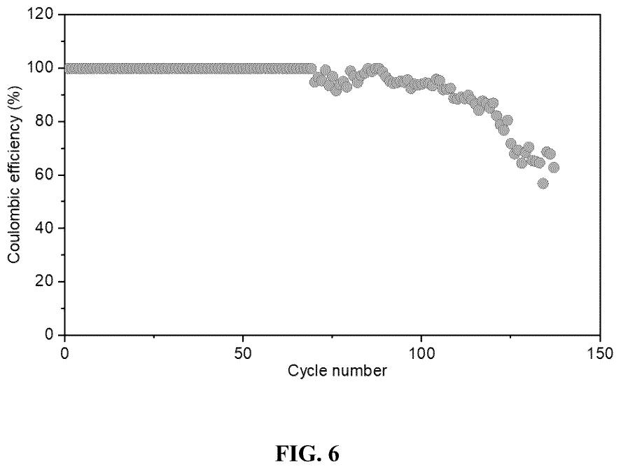

To get a higher energy density, a larger DOD than 40% may be urgently desired. Having further increased the DOD to 60%, the NiOOH∥Zn cell retained capacity for 90 cycles with a 100% coulombic efficiency and continued to function for more than 135 cycles with a specific capacity retention of 60% (FIG. 6).

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “Higher depth of discharge (DoD)” refers to the extent to which the stored electrical energy in a battery is completely discharged during its discharge cycle. In other words, it indicates the proportion of the total energy storage capacity of the battery that is discharged during use. If a battery can achieve a higher depth of discharge, it means it can provide longer operating times or release more electrical energy, which is crucial for applications requiring prolonged usage or significant power delivery.

The term “coin cell” is a specific type of battery that is typically circular in shape, small in size, and resembles a coin, hence the name. Coin cells are commonly used in small electronic devices such as watches, calculators, small sensors, or as power sources in laboratory settings. While coin cells can be disposable, they are often rechargeable, such as silver oxide batteries or lithium-ion batteries.

The “NiOOH layer” refers to nickel oxyhydroxide, which is a layer of material serving as the positive electrode in the battery. This layer is typically formed on the anode (or positive electrode) of the battery and is involved in electrochemical reactions, such as in nickel-metal hydride (NiMH) or nickel-zinc (NiZn) batteries. The NiOOH layer exhibits excellent chemical stability and conductivity, allowing the positive electrode of the battery to efficiently undergo electrochemical reactions and provide the necessary energy.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A rechargeable alkaline battery with enhanced cycling stability and coulombic efficiency, comprising:
a cathode prepared with a cathode material and connected to a first terminal;
an anode prepared with an anode material and connected to a second terminal;
a hydroxide electrolyte comprising a solute and a solvent, with a concentration of at least 10 M, wherein the hydroxide electrolyte inhibits hydrogen evolution from approximately 20% to less than 5% of an overall reaction;
at least one porous separator positioned between the anode and the cathode,
when cycled at 40% DOD under charging and discharging at 15 mA/cm_{Zn}², the rechargeable alkaline battery exhibits a cycling stability with a capacity retention greater than 80% after 290 cycles.

2. The rechargeable alkaline battery of claim 1, further comprising a gasket.

3. The rechargeable alkaline battery of claim 1, wherein the anode material comprises zinc, zinc alloys, zinc hydroxide, zinc oxide, or other zinc compounds of low alkaline solubility.

4. The rechargeable alkaline battery of claim 1, wherein the cathode material comprises nickel oxyhydroxide.

5. The rechargeable alkaline battery of claim 1, wherein the at least one porous separator comprises a nonwoven cellulose membrane, a polymer film, an ion-selective membrane, and a glass fiber separator.

6. The rechargeable alkaline battery of claim 1, wherein the rechargeable alkaline battery comprises nickel-zinc battery, silver-zinc battery, and zinc-air battery.

7. The rechargeable alkaline battery of claim 1, wherein the solute is one or more alkali metal hydroxides selected from lithium hydroxide, sodium hydroxide and potassium hydroxide, calcium hydroxide, aluminum hydroxide, or a combination thereof.

8. The rechargeable alkaline battery of claim 7, wherein the concentration of the one or more alkali metal hydroxides is 1-20 mol/L.

9. The rechargeable alkaline battery of claim 7, wherein the solute further comprises a metallic oxide comprising zinc oxide, alumina, boron oxide, tin oxide, or a combination thereof.

10. The rechargeable alkaline battery of claim 9, wherein the concentration of the metallic oxide is 0.001-5 mol/L.

11. The rechargeable alkaline battery of claim 1, wherein the solvent comprises deionized water, ethanol, and dimethyl sulfoxide.

12. The rechargeable alkaline battery of claim 1, wherein the rechargeable alkaline battery demonstrates an ionic conductivity of at least 0.2 S/cm at room temperature.

13. The rechargeable alkaline battery of claim 1, wherein the hydroxide electrolyte exhibits a practical electrochemical window expanded to at least 2.1 V.

14. The rechargeable alkaline battery of claim 1, when cycled at 60% DOD under charging and discharging at 30 mA/cm_{Zn}², the rechargeable alkaline battery exhibits a capacity retention greater than 95% after 90 cycles, maintaining at least 95% coulombic efficiency, and further sustains operation for over 135 cycles while retaining a specific capacity of at least 60%.
